(19) United States
(12) Patent Application Publication
(10) Pub. No.: US 2013/0013332 A1
(43) Pub. Date: Jan. 10, 2013

(54) SYSTEM AND METHOD FOR PERFORMING PHARMACOVIGILANCE

(75) Inventors: Ophir Frieder, Chevy Chase, MD (US); Howard Federoff, Bethesda, MD (US)

(73) Assignee: GEORGETOWN UNIVERSITY, Washington, DC (US)

(21) Appl. No.: 13/543,044

(22) Filed: Jul. 6, 2012

Related U.S. Application Data
(60) Provisional application No. 61/580,533, filed on Dec. 27, 2011.
(60) Provisional application No. 61/505,402, filed on Jul. 7, 2011.

(51) Int. Cl. G06Q 50/22

(52) U.S. Cl. 705/2

(57) ABSTRACT

A method and system for tracking patient's response during a clinical trial of a drug, includes publishing an informational item about the clinical trial at a social media platform or a file sharing website; inducing patients to post trial related response at the social media platform or to obtain the informational item from the file sharing website; aggregating patients' responses from the social media platform, download information of the informational item published on the file sharing website, or search queries from search engines; and analyzing aggregated patients' responses, download information, or search queries to obtain knowledge related to the clinical trial.

### CROSS REFERENCE TO RELATED APPLICATIONS

This application claims a priority benefit to provisional application Ser. No. 61/505,402, filed on Jul. 7, 2011 and a priority benefit to provisional application Ser. No. 61/580,533, filed on Dec. 27, 2011, each of which are hereby incorporated by reference in their entirety herein.

### BACKGROUND

Clinical trials generally represent research procedures conducted with human subjects or materials of human origin in which investigators interact directly with human subjects. Clinical trials intend to collect safety (or more specifically, information about adverse drug reactions and adverse effects of other treatments) and efficacy data for health interventions (e.g., drugs, diagnostics, devices, therapy protocols). Clinical trials take place after satisfactory information has been gathered on the quality of the non-clinical safety, and Health Authority/Ethics Committee approval is granted by a relevant agency, such as Institutional Review Board (IRB), the U.S. Food and Drug Administration (FDA), and the International Conference on Harmonisation of Technical Requirements for the Registration of Pharmaceuticals for Human Use (ICH).

Clinical trials involving new drugs, medicines, or treatments are commonly classified into five phases including a pre-clinical study, Phase 0 clinical trial, Phase I clinical trial, Phase II clinical trial, Phase III clinical trial, and Phase IV clinical trial. Pre-clinical studies involve experiments using wide-ranging doses of a new drug candidate to obtain preliminary efficacy, toxicity and pharmacokinetic information that is expected to be relevant human subjects. Such tests assist pharmaceutical companies to decide whether a drug candidate has sufficient scientific merit for further development as an investigational new drug.

Phase 0 clinical trials represent first-in-human trials. Phase 0 trials administer reduced doses of a study drug to a small number of patients (10 to 15) to gather preliminary data on metabolism, excretion and distribution, pharmacodynamic parameters and, if possible, patients' responses. Phase 0 clinical trials aim to examine drug candidates to decide which one is fitted for further development and are exploratory.

Phase I trials administer full doses of a study drug to a small number of patients (typically 10 to 30). This phase includes trials designed to assess the safety, tolerability, pharmacokinetics, and pharmacodynamics of a drug. Phase I trials also normally include dose-ranging, also called dose escalation, to find the appropriate dosage for therapeutic use. They may also determine the maximally tolerated dose.

Once the initial safety of the study drug has been confirmed in Phase I trials, Phase II trials are performed on larger groups (typically 30-200) and are designed to assess how well the drug works, as well as to continue Phase I safety assessments in a larger group of volunteers and patients. Phase II studies are sometimes divided into Phase IIA and Phase IIB. Phase IIA is specifically designed to assess dosing requirements (how much drug should be given). Phase IIB is specifically designed to study efficacy (how well the drug works at the prescribed dose(s)).

Phase III trials are randomized controlled multicenter trials on large patient groups (typically 200-2,000 or more depending upon the disease/medical condition studied) and are aimed at being a definitive assessment of how effective the drug is, in comparison with current treatments. Due to their size and comparatively long duration, Phase III trials are expensive, time-consuming and difficult trials to design and run, especially in therapies for chronic medical conditions.

Once a drug is proven satisfactory through Phase III trials, the trial results are usually combined into a large document containing a comprehensive description of the methods and results of human and animal studies, manufacturing procedures, formulation details, and shelf life. This collection of information makes up the “regulatory submission” that is provided for review to the appropriate regulatory authorities in different countries. They, in turn, review the submission, and, potentially grant approval to market the drug.

Each of the above-described phases of the drug approval process is treated as a separate clinical trial. The drug-development process will normally proceed through three of the four phases (I, II, III) over many years. Phase 0 studies are used less frequently. If the drug successfully passes through Phases I, II, and III, it will usually be approved by the national regulatory authority for use in the general population.

Phase IV trial is also known as Post-Marketing Surveillance Trial. Phase IV trials involve the safety surveillance and ongoing technical support of a drug after it receives permission to be sold. Pharmaceutical companies have several objectives at this stage: (1) to compare a drug with other drugs already in the market; (2) to monitor a drug's long-term effectiveness and impact on a patient's quality of life; and (3) to determine the cost-effectiveness of a drug therapy relative to other traditional and new therapies. Post-marketing studies enables companies to expand existing markets or enter new ones, conduct comparative effectiveness analysis, and reinforce market share in increasingly crowded markets. Phase IV studies can result in a drug or device being taken off the market, or restrictions of use could be placed on the product depending on the findings in the study.

Phase IV studies may be required by regulatory authorities or may be undertaken by the sponsoring company for competitive purposes (finding a new market for the drug) or other reasons (for example, the drug may not have been tested for interactions with other drugs, or on certain population groups who are unlikely to subject themselves to trials, such as pregnant women). The safety surveillance is designed to detect any rare or long-term adverse effects over a much larger patient population and longer time period than was possible during the Phase 0-III clinical trials. Harmful effects discovered by Phase IV trials may result in a drug being no longer sold, or restricted to certain uses.

Phase IV clinical trials face many challenges. One of significant differences between Phase 0-III and Phase IV trials is the need to enroll substantially larger numbers of patients for the late-phase studies to produce the required breadth of data. While a Phase III trial might include as few as 1,500 patients and less than 100 site locations (e.g., an office of a clinical research organization), a Phase IV safety or marketing study could encompass 5,000 or more patients at hundreds of site locations. In addition, late-phase or registry studies can run for 5 years or more, compared with 12-18 months for many pre-Phase IV trials. Another challenge is that regulatory agencies around the world are requiring additional data about the long-term safety and side effects of new products when they are used by larger numbers of patients in real-world settings. Yet, another challenge is that healthcare providers—and those who pay for healthcare—are demanding clinical evidence that new therapies provide better outcomes or greater value than existing standards of care. To meet those growing data requirements, biopharmaceutical companies need a wider range of product and safety information, most of which may only be available from Phase IV trials. In summary, Phase IV clinical trials need to efficiently track patients' input and response in a global environment to satisfy the growing demand of information from agencies, healthcare providers, and patients.

Pharmacovigilance as understood in the art refers to science and activities relating to the detection, assessment, understanding and prevention of adverse effects of drugs or any other treatment-related problem. The aims of pharmacovigilance include enhancing patient care and patient safety in relation to the use of medicines, and supporting public health programs by providing reliable, balanced information for the effective assessment of the risk-benefit profile of medicines. Clinical trials including Phase 0-IV trials are examples of tools to perform pharmacovigilance.

### SUMMARY

According to an embodiment, the present disclosure is directed to a method, executed by a processor, for tracking patient's response during a clinical trial of a medical treatment. The method includes publishing an informational item about the clinical trial to at least one social media platform; inducing patients to post trial related response at the at least one social media platform; aggregating patients' responses from the at least one social media platform; and analyzing aggregated patients' responses to obtain knowledge related to the clinical trial.

According to another embodiment, the method further includes aggregating search queries from at least one search engine; and analyzing the search queries to obtain knowledge related to the clinical trial.

According to another embodiment, the method further includes publishing the informational item to at least one file sharing website; aggregating download information for informational item; and analyzing the download information to obtain knowledge related to the clinical trial.

According to another embodiment, the method further includes encrypting identity information of a patient.

According to another embodiment, metadata associated with a patient's response is also aggregated and analyzed.

According to another embodiment, the social media platform includes Facebook, Google+, Twitter, YouTube, LiveJournal, MySpace or LinkedIn.

According to another embodiment, the search engine includes Google, Bing, or Yahoo.

According to another embodiment, the file sharing website includes BitTorrent, EMule, or DocShare.

According to another embodiment, the present disclosure is directed to a system for tracking patient's response during a clinical trial of a medical treatment. The system includes publishing means for publishing an informational item about the clinical trial to at least one social media platform; inducing means for inducing patients to post trial related response at the at least one social media platform; aggregating means for aggregating patients' responses from the at least one social media platform; and analyzing means for analyzing aggregated patients' responses to obtain knowledge related to the clinical trial.

According to another embodiment, the aggregating means further aggregates search queries from at least one search engine; and the analyzing means further analyzes the search queries to obtain knowledge related to the clinical trial.

According to another embodiment, the publishing means further publishes the informational item to at least one file sharing website, the aggregating means aggregates download information for informational item from the at least one file sharing website, and the analyzing means analyzes the download information to obtain knowledge related to the clinical trial.

According to another embodiment, the system further includes encrypting means for encrypting identity information of a patient.

According to another embodiment, metadata associated with a patient's response is also aggregated.

According to another embodiment, the social media platform includes Facebook, Google+, Twitter, YouTube, LiveJournal, MySpace or LinkedIn.

According to another embodiment, the search engine includes Google, Bing, or Yahoo.

According to another embodiment, the file sharing website includes BitTorrent, EMule, or DocShare.

According to another embodiment, the present disclosure is directed to a non-transitory storage medium storing an executable program that, when executed, causes a processor to track patient's response during a clinical trial of a medical treatment. The executable program includes publishing an informational item about the clinical trial to at least one social media platform; inducing patients to post trial related response at the at least one social media platform; aggregating patients' responses from the at least one social media platform; and analyzing aggregated patients' responses to obtain knowledge related to the clinical trial.

According to another embodiment, the present disclosure is directed to a method, executed by a processor, for tracking patient's response during a clinical trial of a medical treatment. The method includes aggregating search queries from at least one search engine; and analyzing the search queries to obtain knowledge related to the clinical trial.

According to another embodiment, the method includes aggregating metadata of search queries. The metadata of search queries include IP address.

According to another embodiment, the present disclosure is directed to a system for tracking patient's response during a clinical trial of a medical treatment. The system includes aggregating means for aggregating search queries from at least one search engine; and analyzing means for analyzing the search queries to obtain knowledge related to the clinical trial.

According to another embodiment, the aggregating means further aggregates metadata of search queries. The metadata includes IP address.

According to another embodiment, the present disclosure is directed to a non-transitory storage medium storing an executable program that, when executed, causes a processor to track patient's response during a clinical trial of a treatment. The executable program includes aggregating search queries from at least one search engine; and analyzing the search queries to obtain knowledge related to the clinical trial.

According to another embodiment, the present disclosure is directed to a method, executed by a processor, for tracking patient's response during a clinical trial of a medical treatment. The method includes publishing the informational item to at least one file sharing website; aggregating download information for informational item; and analyzing the download information to obtain knowledge related to the clinical trial.

According to another embodiment, the method further includes aggregating metadata of search queries. The metadata of search queries include IP address.

According to another embodiment, the present disclosure is directed to a system for tracking patient's response during a clinical trial of a medical treatment. The system includes publishing means for publishing the informational item to at least one file sharing website; aggregating means for aggregating download information for informational item; and analyzing means for analyzing the download information to obtain knowledge related to the clinical trial.

According to another embodiment, the aggregating means further aggregates metadata of search queries. The metadata includes an IP address.

According to another embodiment, the present disclosure is directed to a non-transitory storage medium storing an executable program that, when executed, causes a processor to track patient's response during a clinical trial of a treatment. The executable program includes publishing means for publishing the informational item to at least one file sharing website; aggregating means for aggregating download information for informational item; and analyzing means for analyzing the download information to obtain knowledge related to the clinical trial.

### BRIEF DESCRIPTION OF THE DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 illustrates an exemplary network environment according to an embodiment.

FIG. 2 illustrates an exemplary structure of a computer device according to an embodiment.

FIG. 3 illustrates an exemplary process of the system according to an embodiment.

FIG. 4 illustrates exemplary functional modules of a sponsor terminal according to an embodiment.

FIG. 5 illustrates exemplary functional modules of a trial data tracking system according to an embodiment.

FIG. 6 illustrates an exemplary informational item on YouTube.

FIG. 7 illustrates exemplary data mining results derived from data obtained from YouTube.

FIG. 8 illustrates exemplary comments from users.

### DETAILED DESCRIPTION

It is noted that in this disclosure and particularly in the claims and/or paragraphs, terms such as “comprises,” “comprised,” “comprising,” and the like can have the meaning attributed to them in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The use of the terms “a,” “an,” “at least one,” “one or more,” and similar terms indicate one of a feature or element as well as more than one of a feature. The use of the term “the” to refer to the feature does not imply only one of the feature and element.

When an ordinal number (such as “first,” “second,” “third,” and so on) is used as an adjective before a term, that ordinal number is used (unless expressly or clearly specified otherwise) merely to indicate a particular feature, such as to distinguish that particular feature from another feature that is described by the same term or by a similar term.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate). Similarly, where more than one device, article or other product is described herein (whether or not they cooperate), a single device/article may alternatively be used in place of the more than one device or article that is described. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Furthermore, the detailed description describes various embodiments of the present invention for illustration purposes and embodiments of the present invention include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with one or more electronic storage media.

Embodiments of the present invention may be implemented using one or more processing devices, or processing modules. The processing devices, or modules, may be coupled such that portions of the processing and/or data manipulation may be performed at one or more processing devices and shared or transmitted between a plurality of processing devices.

The present invention will now be described in detail on the basis of exemplary embodiments. The invention disclosed herein, may be practiced using programmable digital computers and networks therefor.

Further, it will be understood that an ordinarily skilled artisan will be familiar with technology for information extraction, relation generation, data mining, summarization, sentiment analysis, similar document detection, databases, information retrieval, data mining techniques, machine translation, cross language retrieval, and natural language processing systems and techniques. Exemplary publications describing material known to ordinarily skilled artisans, the entirety of each of which are incorporated by reference herein, include:
Introduction to Information Retrieval, Manning, Raghavan, and Schütze, Cambridge University Press, 2008.
Data Mining: Concepts and Techniques, Morgan Kaufmann, Han and Kamber, 2006
Database Systems Concepts, McGraw Hill, Silberschatz, Korth, and Sudarshan, 2010.
Graph-based Natural Language Processing and Information Retrieval, Mihalcea and Radev, Cambridge University Press, 2011.
Mining the Social Web, Mathew A. Russell, ISBN: 9781449388348, O'Reilly Media, Inc., 2011.

Various embodiments as described herein are described with examples of a clinical trial of a drug. However, as explained above, clinical trials are designed to collect safety information about adverse drug reactions and adverse effects of other treatments and efficacy data for health interventions including drugs, diagnostics, devices, therapy protocols. Accordingly, as will be understood, a clinical trial for a medical treatment as used herein includes clinical trials for all such health interventions and treatments, and are within the scope of the present invention.

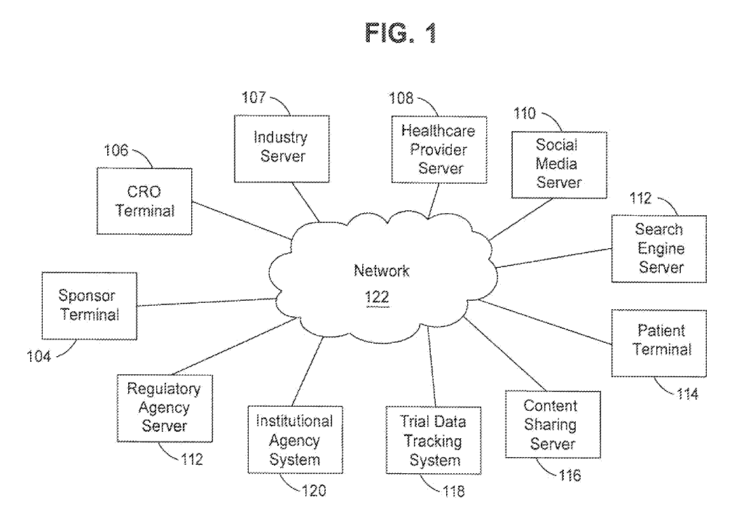

FIG. 1 illustrates an exemplary network environment according to an embodiment.

The network environment 100 includes a network 102 that connects a sponsor terminal 104, a clinical research organization (CRO) terminal 106, a healthcare provider terminal 108, a social media server 110, a search engine server 112, a patient terminal 114, a content sharing server 116, a trial data tracking system 118, an institutional agency system 120, and a regulatory agency system 122.

According to an embodiment, the network 102 is, for example, any combination of linked computers, or processing devices, adapted to transfer and process data. The computer network 102 may be private Internet Protocol (IP) networks, as well as public computer networks, such as the Internet that can utilize World Wide Web (www) browsing functionality. An example of a wired network is a network that uses communication busses and MODEMS, or DSL lines, or a local area network (LAN) or a wide area network (WAN) to transmit and receive data between terminals. An example of a wireless network is a wireless LAN. A cellular network such as Global System for Mobile Communication (GSM) and Enhanced Data rates for GSM Evolution (EDGE) or LTE Advanced is another example of a wireless network. Also, IEEE 802.11 (Wi-Fi) is a commonly used wireless network in computer systems, which enables connection to the Internet or other machines that have Wi-Fi functionality. Wi-Fi networks broadcast radio waves that can be picked up by Wi-Fi receivers that are attached to different computers. Yet, other examples of a wireless network may include a 3 G communication network or a 4 G communication network. Yet another example of a wireless network is near field communication (NFC)—a set of short-range wireless technologies. NFC typically operated at a distance of 4 cm or less at rates ranging from 106 kbits to 848 kbit/s. NFC involves an initiator that generates an RF field, which in turn powers a passive target. The NFC target can take simple form factors such as tags, stickers, key fobs, or cards that do not require batteries, but can also be used in conjunction with smart cards or phones incorporating NFC functionality.

The sponsor terminal 104 may be operated by a sponsor who may be any party sponsoring a Phase IV clinical trial, for example, a pharmaceutical company. As will be understood throughout, although the present disclosure describes exemplary embodiments in the context of a Phase IV Clinical. Trial, embodiments need not be limited to Phase IV Clinical Trials as the present disclosure may be equally applied to Phase 0 to Phase III clinical trials. The pharmaceutical company may own an approved drug and conduct a Phase IV clinical trial for that drug. In the alternative, the pharmaceutical company may be a competitor to the pharmaceutical company who owns the particular drug of concern and conduct a Phase IV clinical trial for that drug. The sponsor terminal 104 may also be operated by an agency, such as the National Institutes of Health, who is conducting a Phase IV clinical trial for a particular drug. The pharmaceutical company or the agency may design a protocol for the clinical trials, contract with many research centers, hospitals, healthcare providers, and agencies to conduct the clinical trial, induce patients to participate in the clinical trial, and enforce a compliance of the practice with all relevant guidance and regulations.

The CRO terminal 106 may be hosted or provided by a clinical research organization, which represents a person or an organization (commercial, academic, or other) contracted by a sponsor to perform one or more of a sponsor's trial-related duties and functions. Clinical research organizations provide the pharmaceutical and biotechnology industries with pharmaceutical research services (for both drugs and medical devices). Exemplary CRO organizations include Quintiles, Pharmaceutical Product Development, Covance, Charles River Laboratories, Parexel, ICON, Kendle, PharmaNet Development Group, PRA International, and 4G Pharmacovigilance LLP.

The healthcare provider terminal 108 may be operated by a healthcare provider such as a pharmacy, a hospital, a clinic, a solo practitioner, a practice group, or an emergency center. The healthcare provider can inform and encourage patients to participate in a clinical trial and provide necessary information to interested patients. The healthcare provider can offer patients the opportunity to give comments and responses for a medicine or a new treatment and allow the trial data tracking system 118 to collect those comments and responses.

An industry host terminal 107 may be hosted or provided by a person or an organization (commercial, academic, or other healthcare industry organization) who hosts or sponsors health industry events, such as “Industrial Days.” Industrial Days are events where relationships between companies are created to raise awareness of research directions and trends, and to stimulate the exchange of scientific ideas and dialogue. The industry host or sponsor can inform and encourage parties to participate and share clinical trial data and provide necessary information to attendees or interested parties. The host, sponsor, or other parties involved in the event can offer parties having information on new medicines or new treatments the opportunity to give information and allow the trial data tracking system 118 to collect that information. The host can also provide information to healthcare providers and other parties to create programs and incentives to encourage patients to provide clinical trial data.

The social media server 110 is operated by a social media platform, such as Facebook, Google+, MySpace, Twitter, LinkedIn, Flickr, YouTube, etc. Social media platforms include social media or social networking websites such as Facebook, Google+, MySpace, and FourSquare. Social media platforms also include information networks or social information networks such as Twitter, YouTube, Flickr, and Digg. Social media platforms, also called Web 2.0 websites, include those websites that facilitate to a greater extent participatory information sharing, interoperability, user-centered design, and collaboration than Web 1.0 websites. The social media server 110 allows a pharmaceutical company or an agency to publish information about a clinical trial and allows members to comment on the published information. The social media server 110 may represent many terminals operated by a same party and allow input from many countries in many languages. A simplified network architecture for a social media platform includes a server, a network, and a population of web-based social network members. The server can also comprise web-based social network databases, which can include a web-based database of any entity that provides web-based social networking services, communication services and/or social interaction services.

The search engine server 112 is operated by a search engine website, such as Google, Yahoo, Bing, Baidu, etc. The search engine server 112 keeps a log of queries input from users around the world. The search engine server 112 may provide the log of queries to the trial data tracking system 118 to discover clinical trial related queries.

The patient terminal 114 may be operated by a patient, who may participate in the clinical trial or who may have genuine interests in the drug included in the clinical trial. The patient may give feedback or comments on the usage, effects, or any related information of the drug to the CRO terminal 106, the healthcare provider terminal 108, the social media server 110, etc. The patient or person taking the drug may use the search engine server 112 to search and obtain certain information of the drug or the clinical trial.

The content sharing server 116 may be operated by a website that provides file storage and sharing services, such as BitTorrent, EMule, FileSonic, DocShare, etc. The content sharing server 116 also keeps a log of file sharing history and may, upon an agreement, provide the log of file sharing history to the trial data tracking system 118 to discover related sharing of a drug.

The trial data tracking system 118 may be hosted by a party that provides a service of data tracking to a pharmaceutical company or an agency. The trial data tracking system 118 may aggregate trial related information from multiple sources, recode the aggregated data, analyze the data, and report discoveries. The trial data tracking system 118 may also track policy or regulation updates and examine the compliance of the trial practice with the updated policy and regulations.

The institutional agency system 120 may be hosted by a non-regulatory agency that provides guidance to the clinical trial. Example of a non-regulatory agency includes IRB and ICH. IRB refers to a committee that has been formally designated to approve, monitor, and review biomedical and behavioral research involving humans with the aim to protect the rights and welfare of the research subjects.

The regulatory agency system 122 may be hosted by a government agency that regulates the clinical trial practice. In the U.S., a government agency includes FDA, NIH, etc. It will be understood that the embodiments disclosed herein, while discussed in terms of US Regulatory Schemes for a Phase IV clinical trial, is equally applicable in other national or jurisdictionally regulated regimes for clinical trials for all phases and the subsequent monitoring of authorized or actively used medicines, as for example, the European Unions' network of national medicines agencies (e.g., the UK's Medicines and Healthcare products Regulatory Agency (MHRA)) and the European Medicines Agency's Committee for Medicinal Product for Human Use, which engages in EU-wide pharmacovigilance activity by closely monitoring reports of potential safety concerns.

According to an embodiment, each of the terminals, servers, and systems may be, for example, a server computer or a client computer operatively connected to network 102, via bi-directional communication channel, or interconnector, respectively, which may be for example a serial bus such as IEEE 1394, or other wire or wireless transmission medium. The terms “operatively connected” and “operatively coupled”, as used herein, mean that the elements so connected or coupled are adapted to transmit and/or receive data, or otherwise communicate. The transmission, reception or communication is between the particular elements, and may or may not include other intermediary elements. This connection/coupling may or may not involve additional transmission media, or components, and may be within a single module or device or between the remote modules or devices.

The terminals, servers, and systems are adapted to transmit data to, and receive data from, each other via the network 102. The terminals, servers, and systems typically utilize a network service provider, such as an Internet Service Provider (ISP) or Application Service Provider (ASP) (ISP and ASP are not shown) to access resources of the network 102.

Although each of the above described terminal, server, and system may comprise a full-sized personal computer, the system and method may also be used in connection with mobile devices capable of wirelessly exchanging data with a server over a network such as the Internet. For example, the patient terminal 114 may be a wireless-enabled PDA such as an iPhone, an Android enabled smart phone, a Blackberry phone, or another Internet-capable cellular phone.

Although only a few terminals, servers, and systems are depicted in FIG. 1, it should be appreciated that a typical system can include a large number of connected computers, with each different computer potentially being at a different node of the network 102. The network, and intervening nodes, may comprise various configurations and protocols including the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computers, such as modems (e.g., dial-up, cable or fiber optic) and wireless interfaces.

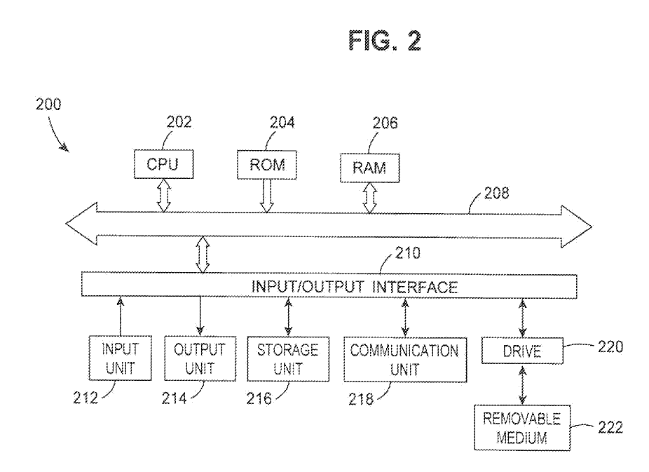

FIG. 2 illustrates an exemplary structure of a server, system, or a terminal according to an embodiment.

The exemplary server, system, or terminal 200 includes a CPU 202, a ROM 204, a RAM 206, a bus 208, an input/output interface 210, an input unit 212, an output unit 214, a storage unit 216, a communication unit 218, and a drive 220. The CPU 202, the ROM 204, and the RAM 206 are interconnected to one another via the bus 208, and the input/output interface 210 is also connected to the bus 208. In addition to the bus 208, the input unit 212, the output unit 214, the storage unit 216, the communication unit 218, and the drive 220 are connected to the input/output interface 210.

The CPU 202, such as an Intel Core™ or Xeon™ series microprocessor or a Freescale™ PowerPC™ microprocessor, executes various kinds of processing in accordance with a program stored in the ROM 204 or in accordance with a program loaded into the RAM 206 from the storage unit 216 via the input/output interface 210 and the bus 208. The ROM 204 has stored therein a program to be executed by the CPU 202. The RAM 206 stores as appropriate a program to be executed by the CPU 202, and data necessary for the CPU 202 to execute various kinds of processing.

A program may include any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The input unit 212 includes a keyboard, a mouse, a microphone, a touch screen, and the like. When the input unit 212 is operated by the user, the input unit 212 supplies an input signal based on the operation to the CPU 202 via the input/output interface 210 and the bus 208. The output unit 214 includes a display, such as an LCD, or a touch screen or a speaker, and the like. The storage unit 216 includes a hard disk, a flash memory, and the like, and stores a program executed by the CPU 202, data transmitted to the terminal 200 via a network, and the like.

The communication unit 218 includes a modem, a terminal adaptor, and other communication interfaces, and performs a communication process via the networks of FIG. 1.

A removable medium 222 formed of a magnetic disk, an optical disc, a magneto-optical disc, flash or EEPROM, SDSC (standard-capacity) card (SD card), or a semiconductor memory is loaded as appropriate into the drive 220. The drive 220 reads data recorded on the removable medium 222 or records predetermined data on the removable medium 222.

One skilled in the art will recognize that, although the data storage unit 216, ROM 204, RAM 206 are depicted as different units, they can be parts of the same unit or units, and that the functions of one can be shared in whole or in part by the other, e.g., as RAM disks, virtual memory, etc. It will also be appreciated that any particular computer may have multiple components of a given type, e.g., CPU 202, Input unit 212, communications unit 218, etc.

An operating system such as Microsoft Windows 7®, Windows XP® or Vista™, Linux®, Mac OS®, or Unix® may be used by the terminal. Other programs may be stored instead of or in addition to the operating system. It will be appreciated that a computer system may also be implemented on platforms and operating systems other than those mentioned. Any operating system or other program, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

Data may be retrieved, stored or modified in accordance with the instructions. For instance, although the system and method is not limited by any particular data structure, the data may be stored in computer registers, in a relational database as a table having a plurality of different fields and records, XML documents, flat files, etc. The data may also be formatted in any computer-readable format such as, but not limited to, binary values, ASCII or Unicode. The textual data might also be compressed, encrypted, or both. By further way of example only, image data may be stored as bitmaps comprised of pixels that are stored in compressed or uncompressed, or lossless or lossy formats (e.g., JPEG), vector-based formats (e.g., SVG) or computer instructions for drawing graphics. Moreover, the data may comprise any information sufficient to identify the relevant information, such as numbers, descriptive text, proprietary codes, pointers, references to data stored in other memories (including other network locations) or information that is used by a function to calculate the relevant data.

It will be understood by those of ordinary skill in the art that the processor and memory may actually comprise multiple processors and memories that may or may not be stored within the same physical housing. For example, some of the instructions and data may be stored on removable memory such as a magneto-optical disk or SD card and others within a read-only computer chip. Some or all of the instructions and data may be stored in a location physically remote from, yet still accessible by, the processor. Similarly, the processor may actually comprise a collection of processors which may or may not operate in parallel. As will be recognized by those skilled in the relevant art, the terms “system,” “terminal,” and “server” are used herein to describe a computer's function in a particular context. A terminal may, for example, be a computer that one or more users work with directly, e.g., through a keyboard and monitor directly coupled to the computer system. Terminals may also include a smart phone device, a personal digital assistant (PDA), thin client, or any electronic device that is able to connect to the network and has some software and computing capabilities such that it can interact with the system. A computer system or terminal that requests a service through a network is often referred to as a client, and a computer system or terminal that provides a service is often referred to as a server. A server may provide contents, content sharing, social networking, storage, search, or data mining services to another computer system or terminal. However, any particular computing device may be indistinguishable in its hardware, configuration, operating system, and/or other software from a client, server, or both. The terms “client” and “server” may describe programs and running processes instead of or in addition to their application to computer systems described above. Generally, a (software) client may consume information and/or computational services provided by a (software) server.

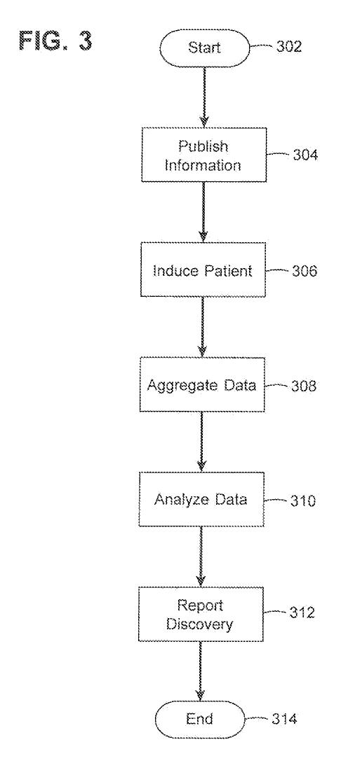

FIG. 3 illustrates exemplary high level processing of the method according to an embodiment.

The process starts at step 302. At step 304, a sponsor such as a pharmaceutical company or an agency (Hereinafter, “Sponsor”) prepares a Phase IV clinical trial (hereinafter, merely “Trial”) of an approved drug. The sponsor designs trial protocols and contracts with various parties that participate in the trial. The sponsor produces a publication of the trial and makes the publication available on several sources, such as hospitals, physician's offices, social media platforms, TV, etc. According to an embodiment, a technology provider (hereinafter, “Provider”) tracks and analyzes patient's responses and comments about the publication, especially those posted on a online source such as social media platforms, blogs, search engines, etc. According to another embodiment, the sponsor may implement a tracking and analyzing software provided by the technology provider in its own computer system. The publication includes drug related informational items such as mechanism of a drug, dietary information when taking a drug, drug-drug interactions, quality of life associated with the treatment, etc. The publication may include a URL link that directs an interested patient to an online source for participating in the trial and posting comments. The publication may include a barcode or a graphical item that will bring up an online page when the barcode or the graphical item is scanned by a smart phone.

According to an embodiment, the sponsor creates a user identifier for each Phase IV drug of interests and uses that identifier to publish an informational item related to the drug in the trial. An example of the identifier may be #Choice-Drug-Phase-IV. The sponsor may post the informational item on Facebook, Google+, or the sponsor may tweet the informational item on Twitter.

Patients may be registered to participate in the trial. The registration may be conducted at the social medial platform, the sponsor's website, by mail, by email, at a healthcare provider's office or website, or at a CRO's website or office. Upon registration, patients or persons taking the drug, hereafter termed “patients”, may be given a patient identifier that de-identifies the patient's true identity by encrypting his or her name. According to another embodiment, patients may use any identifiers or names they prefer, and when a patient posts a comment using a plain name, that plain name is identified and encrypted so that the patient's identity is concealed. Patients use the above-described names to befriend (Facebook) or follow (Twitter) the drug of interest. Patients may email, text, tweet, or post messages to the sponsor. The messages can be designated as public or private based on patient's settings.

According to another embodiment, the sponsor creates a user identifier for each Phase IV drug for a social media platform, such as LinkedIn. The sponsor invites known patients, for example, patients that the sponsor knows have or are taking the drug of the trial, to become a member of the community. Participants can view the participant list. However, the identities of the participants might be concealed or encrypted. Invitations may encrypt the identity of the sender of the invitation. The receiver of the invitation might likewise be encrypted. Global invitations can be sent as a broadcast message. Invitations can be propagated or generated by physicians and patients that know of other interested parties.

According to and embodiment, the sponsor publishes an informational item on an “Industry Page” of a social media platform such as LinkedIn, Facebook, or Google+. An Industry Page is similar to a user page or business page on the social media platform, where the user identifier can be created for the Industry segment or subsegment. The Industry Page can also include documents, videos, links and other information related to Industry segment or subsegment on the Industry Page. Users are allowed to download the informational item.

As with creating a user identifier on the platform, a sponsor or other party can invite known patients, for example, patients that the sponsor knows have or are taking the drug of the trial, to join or follow the industrial page. Participants can view the participant list. However, the identities of the participants might be concealed or encrypted. Invitations may encrypt the identity of the sender of the invitation. The receiver of the invitation might likewise be encrypted. Global invitations can be sent as a broadcast message. Invitations can be propagated or generated by physicians and patients that know of other interested parties. Patients can also be incented to join or follow the page of their own accord, and can be offered a method of doing so privately using techniques for concealing the identity of a user as described herein.

It will be appreciated that embodiments include technology for incentivizing and rewarding users, as for example as described in, Anhai Doan, Raghu Ramakrishnan, and Alon Halevy, “Crowdsourcing Systems on the World-Wide Web”, Communications of the ACM, 54(4), pp 86-96, April 2011, the entirety of which is incorporated by reference herein.

According to another embodiment, the sponsor creates a set of video identifiers for each Phase IV drug. The sponsor posts informational items such as videos about the drug. Patients post comments of the drug of interest using the above-described names. The comments can be designated as public or private based on the user's privacy settings.

According to another embodiment, the sponsor publishes an informational item on a content sharing server such as EMule, BitTorrent, and DocShare. Users are allowed to download the informational item. Users can search the content sharing sites for a particular informational item. The content sharing site keeps a log of the following information: queries entered by all users, returned results associated with all queries, downloaded materials, and IP addresses associated with each query and download.

At step 306, the sponsor makes efforts to induce patients to participate in the trial. The sponsor may inform patients about the trial by mail, email, TV advertisement, social media platform's advertisement, an Industry Page, etc. A Sponsor can also make efforts to get parties who interact with patients, such as healthcare providers, to induce patients to participate. For example, a Sponsor may host, sponsor, or otherwise participate in Industrial Days to inform healthcare providers of the benefits of trial participation. The sponsor or other parties can then entice and motivate patients to volunteer for the trial and provide the needed information by providing, for example, incentives, such as:

“Preferred/quicker/higher-priority” access to healthcare provider feedback; discounted prices on prescription refills; up to date information on disease and treatment, easier and centralized access to healthcare and support recourses, and support group formation for those suffering from the same disease.

Following the information in the publication, patients who are interested in the trial may register as a participant of the trial through a website or Industry Page designated by the sponsor and give feedback to the sponsor through social media platforms. Registration may also be done in a healthcare provider's office. Patients may also give comments to the trial without a registration with the sponsor, for example via a user page, Industry Page or community on a social media platform. Again, patient identity may be protected as described previously.

At step 308, the technology provider starts tracking patient input about the drug included in the trial immediately after the publication is available to the public. The technology provider aggregates data from all sources identified by the sponsor. The technology provider also aggregates data from sources that are not identified by the sponsor, such as search engines and blogs in different countries that discuss the drug or the trial. The technology provider collects all the comments published or posted by a registered participant and collects all the comments published or posted by any user that are deemed related to the trial. The technology provider continuously aggregates data as long as the trial is not completed.

At step 308, the technology provider also recodes the aggregated data to convert data from various sources into structured data. The recoded data includes standard fields such as identifier of the data, identifier of the author, profiles of the author, comments made by the authors, demographics of the author, social connections of the author, source, etc. The recoded data are saved in a database and stored either in a local disk or in a virtual online storage such as cloud storage.

At step 310, the technology provider analyzes the data according to the source of the data. As data are aggregated from different sources, an analyzing algorithm is tailored for each source to properly analyze data from that source. For example, each of the social media platforms, search engines, and file sharing websites has a distinct data set. Social media's data include patient's comments on a publication, patient's identification, tags assigned to a comment, patient's tweethetweet, patient's connections, etc. Even among all the social media platforms, data from Facebook, Google+, Twitter, Linkedln, and YouTube has different content and formats. A search engine's data includes all queries and their associated IP addresses. The search engine's data may not include a searcher's identification other than the IP addresses. Data from content sharing websites can include the downloading frequency and period of a file and the IP address of a downloader. The step 310 may produce histograms, timelines, profiles, trends, etc. to assist understanding of patients' input. At step 310, a compliance of the practice with relevant regulations is also checked to ensure that the ethical or privacy requirements are satisfied.

At step 312, the technology provider reports the analyzed results to the sponsor or reports the analyzed results to other parties upon a request from the sponsor. Also at step 312, all the findings are reported to the sponsor after the analyzing of the aggregated data is finished or may be reported up-to-date findings to the sponsor periodically or may be reported findings to the sponsor anytime the sponsor requests such. Step 312 may also prepare reporting forms to report the findings to a regulatory agency such as FDA.

The method ends at step 314.

Patient's identity and privacy can be protected when a Phase IV clinical trial is conducted as disclosed herein. The identity of participants and authors whose data have been collected are concealed. In general, the protection of patient privacy is expected and, in some cases, e.g., by HIPAA regulation, mandated. Patient's identity may be abstracted in several ways according to the present disclosure.

According to an embodiment, when a patient is registered, a participant ID can be generated by hashing the patient's identity information. The participant ID can be used by the patient for identification purpose in the trial and may be used by the sponsor to track the patient. As the participant ID is generated by hashing, the participant ID includes letters and characters, the combination of which show no semantic meanings.

According to another embodiment, when data are aggregated, identification information of a participant, a patient, or an author, such as names, social security numbers, email addresses, and nicknames, are identified. Identification information is encrypted by cryptographic hashes that preserve uniqueness but obfuscate identity. Hashes may be based on a combination of fields such as social security numbers, names, birth dates, etc. According to an embodiment, hashes are based solely on social security numbers. Exemplary hash functions include NSA driven hashes (SHA-1, SHA-256, SHA-512, and MD5) and academic driven hashes (RIPEMD-128, RIPEMD-256, and RIPEMD-320). According to another embodiment, options representing various levels of privacy protections are provided to a patient when that patient inputs comments or responses on a social media platform. By setting a privacy level, a patient may allow his or her identity to be hashed or to be blocked from being displayed.

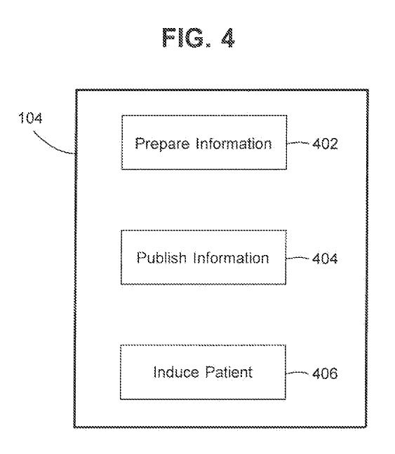

FIG. 4 illustrates exemplary functional modules of the sponsor terminal according to an embodiment.

The sponsor terminal 104 may include a preparation module 402 that prepares an informational item to be published for the trial, a publication module 404 that publishes the informational item on various sources, and an inducement module 406 that induces patients to participate in the trial. The preparation module 402 prepares an informational item related to an approved drug. The informational item may be an article, an animation, or a video. The informational item may include the name of the drug, names of diseases treatable by the drug, mechanisms of the treatment, dosage, quality of life while taking the drug, benefits, possible adverse effects, patient's testimonies, research efforts, etc. The publication module 404 may choose to publish the informational item on a social media platform, such as Facebook, Google+, LinkedIn, Twitter, YouTube, and MySpace, on a content sharing website, such as DocShare, EMule, and BitTorrent, or on a blogger website, such as Blogger, MyBlogLog, and LiveJournal. The publication module 404 keeps a log of where the informational item has been published. The inducement module 406 implements many means to induce patients to participate in the trial. For example, the inducement module 406 can show a video advertisement or presentation to inform patients about the trial, how to participate in the trial, and benefits of participation. The inducement module 406 can also present an online advertisement from the social media platform. The inducement module 406 can also generate a handout or poster, which can be given to a patient at a physician office or hospital to inform the patient about the trial. An objective of the inducement module 406 is to direct an interested patient to a social media platform where the informational item has been published and direct an interested patient to input comments and responses related to the drugs in the informational item. The inducement module 406 may use a plurality of incentives to entice or encourage a patient, including potential preferred access to healthcare provider feedback, potential discounted prices on prescription refills, or support group formation and hosting for those suffering similar diseases.

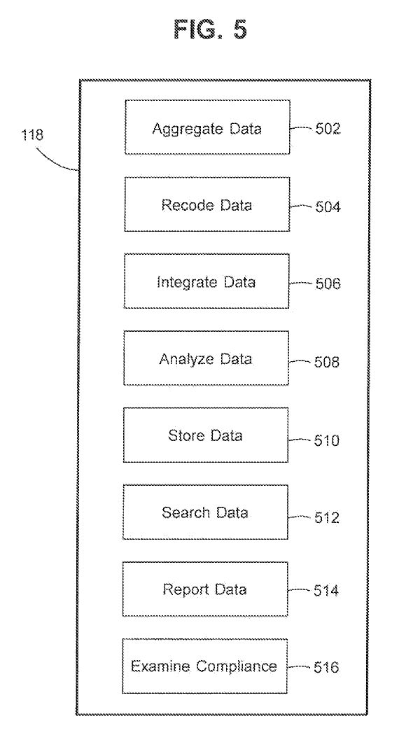

FIG. 5 illustrates exemplary functional modules of the data tracking system according to an embodiment.

According to an embodiment, the data tracking system 118 may implement an aggregation process, a recoding process, and a process to explore, aggregate, recode, and analyze, including via data mining, comments and inputs published in one or more online sources related to the drug concerned in the trial. Specifically, the data tracking system 118 tracks and aggregates data from social media platforms, search engine, and file sharing websites. After the trial data are aggregated, structured, and stored in a database, the data tracking system 118 may implement any known data mining algorithm that is deemed appropriate by a person of ordinary skill in the art, such as those processes described in the book of “Social Network Data Analytics”, Charu C. Aggarwal, Springer, 1^{st} Edition, Mar. 17, 2011, ISBN-10: 1441984615, ISBN-13: 978-1441984616, the entirety of which is incorporated herein by reference, and/or those functions described in U.S. Pat. No. 6,789,091 to Victor Gogolak, “Method and System for Web-Based Analysis of Drug Adverse Effects,” the entirety of which is incorporated herein by reference.

The tracking system 118 includes an aggregation module 502 that aggregates data from various sources, a recoding module 504 that recodes aggregated data according to a predetermined format, an integration module 506 that integrates data from the various sources, an analyzing module 508 that analyzes the data, a storage module 510 that stores the data in a local medium or an on-line medium, a searching module 512 that searches the data, a reporting module 514 that reports findings discovered based on the data, and a compliance module 516 that examines and confirms the compliance of the practice with relevant regulations.

The aggregation module 502 aggregates data from many online sources including social networking sites, search engine logs, file sharing sites, and healthcare provider's sites. The aggregation module 502 may implement any known algorithm for collecting data, such as those described in U.S. Pat. No. 7,886,600 to Jared Polis et. al., “Aggregation System For Social Network Sites,” the entirety of which is incorporated by reference herein.

According to an embodiment, the aggregation module 502 aggregates trial related data from Facebook and Twitter, after the sponsor posts an informational item on Facebook, Google+, or tweets the informational item on Twitter, patients use encrypted names befriend (Facebook) or follow (Twitter) drug of interest. Patients may email, tweet, or post messages to the sponsor. The messages may be designated as public or private based on patient's settings. The aggregation module 502 aggregates patient's identifier, comments, and profile information of the patient if the patient has allowed it to do so. The aggregation module 502 can specifically track a patient's comments if that patient is registered in the trial. The aggregation module 502 also collects all comments that include the drug's brand name or the drug's chemical name.

According to another embodiment, the aggregation module 502 aggregates trial related data from LinkedIn. The aggregation module 502 collects connection information of a patient, such as to which communities the patient belongs and with which user the patient connects.

According to another embodiment, the aggregation module 502 aggregates trial related data from YouTube. After the sponsor posts informational items such as videos about the drug, patients post comments of the drug of interest using encrypted names. The comments may be designated as public or private based on the user's privacy settings. The aggregation module 502 collects all the comments posted for that informational item.

According to another embodiment, the aggregation module 502 aggregates trial related data from Yahoo, Google, and Bing. The aggregation module 502 collects all logged queries and associated search results.

According to another embodiment, the aggregation module 502 aggregates trial related data from EMule, BitTorrent, and DocShare. The aggregation module 502 collects all queries and returned results, the download log of the published informational items.

According to another embodiment, the aggregation module 502 aggregates trial related data from Blogger, MyBlogLog, and LiveJournal. The aggregation module 502 collects articles published by a blogger in which the drug name or the sponsor's name is mentioned and comments associated with that article. The aggregation module 502 also collects articles published by a blogger who is a known patient and comments associated with that article.

According to another embodiment, the aggregation module 502 collects the meta information of every comment posted on an on-line source. The meta information includes tag, IP address, date/time, country, etc. A tag contains user comments or indication of a classification of that comment. Among the meta information, folksonomies, which represent user-generated classification and emerges through a bottom-up consensus, have been used by many social media platforms. Social media platforms allow a user to freely add keywords in a tag of a comment. As a result, a tag may provide additional information for correction of an analysis. Tags may represent information about content, context, attribute, ownership, opinion, emotion, organization, and purpose. An algorithm of assigning and analyzing tags of a file has been described in U.S. Pat. No. 7,720,869 to Ophir Frieder, et. al., “Hierarchical Structured Abstract File System,” the entirety of which is incorporated herein by reference.

The recoding module 504 recodes the aggregated data obtained by the aggregation module 502. The aggregated data includes original copies of articles, comments, inputs, keywords, and metadata associated with the original copies. According to an embodiment, the recoding module 504 may generate, for each copy of data obtained by the aggregation module 502, a database entry that includes a plurality of fields, such as identifier, source's name, date, time, IP address, patient's name, patient's email address, patient's gender, patient's age, other names used by the same patient, patient's friends, patient's comments, opinion analysis, etc. The recoded data generated by the recoding module 504 can be searchable and be analyzed by other functional modules. According to another embodiment, the recoding module 504 can identify, correct, and expand acronyms. According to another embodiment, the recoding module 504 may correct and unify spelling of words. According to another embodiment, the recoding module 504 may identify and translate articles or comments into a preferred language such as English. According to another embodiment, the recoded data are tagged via an XML style approach.

The integration module 506 may integrate the recoded data generated by the recoding module 504. As the data may be aggregated from a plurality of sources, a patient may post comments on a similar subject at a plurality of sources. According to an embodiment, the integration module 506 determines whether a patient publishes similar comments at more than one social media platforms. If so, the integration module 506 may link the similar comments posted by a same patient. According to another embodiment, the integration module 506 may clean the recoded data by combining similar comments posted by the same patient.

The analyzing module 508 analyzes the aggregated data to discover knowledge pertinent to the trial. The analyzing module 508 may analyze any one of the original copy of the data, the recoded data, or the integrated data. According to an embodiment, the analyzing module 508 performs an opinion analysis of the information posted by a patient. An example of such an opinion analysis is described in U.S. Pre-Grant Publication No. 2009/0048823 to Bing Liu et. al., “System and Methods for Opinion Mining”, the entirety of which is incorporated herein by reference. Another example of an opinion analysis is described in U.S. Pre-Grant Publication No. 2009/0319518 to Nick Koudas, et. al., “Method and System for Information discovery and Text Analysis”, the entirety of which is incorporated herein by reference.

According to an embodiment, the analyzing module 508 generates a plurality of metrics and a plurality of charts based on the data. For example, the analyzing module 508 may obtain a list of keywords representing adverse effects of a drug. Each keyword may associate with a frequency (histogram) representing number of times it has been cited or associated with a percentile representing a percentage of recitations of the keyword among all the keywords. In another example, the analyzing module 508 may obtain a number of medicines co-prescribed or taken at the same time with the drug of interest and determines frequencies of adverse effects linked to each co-prescribed medicine. In another example, the analyzing module 508 may obtain a list of geographical locations based on IP addresses and produce a chart showing a relation of geographical locations with adverse effects or any benefits. In another example, the analyzing module 508 may classify patients into a plurality of groups based on age, gender, race, nationality, income level, or educational level. Then, the analyzing module 508 may produce a plurality of charts showing relationships between adverse effects or benefits and the above-identified classifications. According to another embodiment, all tags on a per user, location, etc., are integrated to form a composite view.

According to another embodiment, the analyzing module 508 implements analyzing algorithms based on a source of the data, whose data may have different content or format for different sources. If the data are obtained from a social media platform, the data may include comments, tweets, retweets, user's identification, metadata, and other patient's response to that comment. The analyzing module 508 may identify keywords, location, opinion, etc. If the data are obtained from a search engine, the data may include search queries, search results, and IP addresses. The analyzing module 508 may implement a data mining process of these search queries. An example of such a mining process of search queries is described in “Mining Query Logs: Turning Search Usage Data into Knowledge”; Fabrizio Silvestri, Foundations & Trends in Information Retrieval, 4 (1-2), pp 1-174, 2010, the entirety of which is incorporated herein by reference. If the data are obtained from a file sharing website, the data may include search queries and results, downloaded materials and frequency. The analyzing module 508 may implement data discovery processes that are supported by the contents of the data.

According to another embodiment, the analyzing module 508 can implement a graph mining of overlapping membership graphs and correlate profiles for demographics, characteristics, symptoms, factors, etc. regarding patients. The analyzing module 508 can implement a Twitter “real time trends” detecting for reoccurring conditions. The analyzing module 508 can implement a standard supervised or unsupervised mining process.

According to another embodiment, the analyzing module 508 may implement any one of the following data analyzing functions, including information extraction, relation generation, summarization, sentiment analysis, and similar document detection.

According to another embodiment, the analyzing module 508 can implement a data mining tool provided by or for a social media platform.

The storage module 510 stores the aggregated data, the recoded data, and the integrated data. According to an embodiment, the storage module 510 stores the data in a local storage medium such as a hard disk. According to another embodiment, the storage module 510 stores the data in plurality of storage mediums. According to another embodiment, the storage module 510 stores the data in an online storage medium such as Cloud storage.

The searching module 512 implements a searching function that searches the data based on search queries input by a user. The searching module 512 may implement two search modes: a first search mode that uses SQL language and a mediator style mode that allows a user to use natural language as search queries over diversely formatted data. An example of mediator style mode of querying is described in U.S. Pat. No. 6,904,428 to Ophir Frieder et. al., “Intranet Mediator”, the entirety of which is incorporated herein by reference. The search module 512 allows cross language retrieval. For example, a user may input a query in English, the search module 512 may search the stored data in all languages and return search results in many languages.

The reporting module 514 reports knowledge, metrics, charts, or discoveries obtained by the analyzing module 508 to the sponsor or to any relevant parties such as regulatory agencies or business partners.

The compliance module 516 examines whether the practice complies with all relevant regulations. The compliance module 516 updates its databases periodically or whenever new guidance is issued. The compliance module can examine how the system handles the financial relationships among partners of the trial, patient's consent, and patient's privacy of the trial.

The present disclosure describes embodiments that offer many advantages to the sponsor who is using the disclosed system and method in a Phase IV clinical trial. It allows a more rapid determination of safety that comports with progressive FDA mandates, enables mining of extended indications from anticipated off-label use, reveals drug interactions earlier than a traditional method, and refines the optimal patient populations for treatment. It can also make a sponsor such as a pharmaceutical company to be perceived as more trustworthy from patient, provider, and regulatory perspectives. Embodiments as disclosed herein enable, among other things, pharmaceutical companies and relevant agencies to quickly collect and analyze large amounts of data to determine whether or not an approved drug may have safety or tolerability concerns that need to be addressed. Other exemplary advantages include the ability to conduct pharmacovigilance on a global scale, which provides early warning signals about, inter alia, tolerability or safety issues, which permits companies to more quickly determine whether or not label changes, product recalls, or additional clinical trials may be appropriate. Yet another exemplary advantage includes promptly, globally, and accurately tracking and analyzing post-New Drug Application (NDA) data that result in a better profile of safety and efficacy and more efficient interactions with related parties.

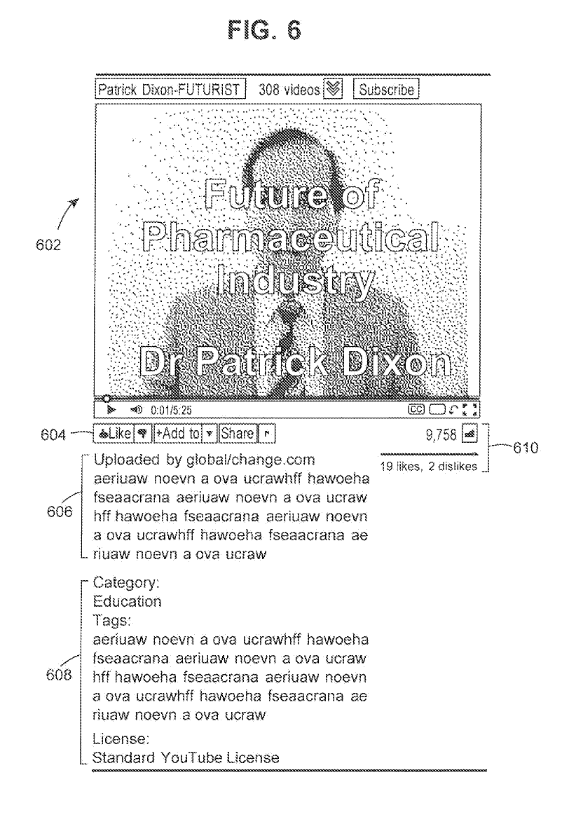

FIGS. 6 to 8 illustrate exemplary data that are published on a social media platform and that is aggregated by the method.

FIG. 6 illustrates an exemplary informational item published on YouTube. The informational item may include a movie 602, an introduction 606, and user's settings 608. The movie 602 represents information about a newly approved drug, the purpose of a Phase IV clinical trial, protocols, sponsors, etc. The introduction 606 can include texts describing the movie and contents of the movie. The user's setting 608 can include information of category, tags, and license whose values are set by the user or by the social media platform. Specifically, examples of tag information in the user's setting 608 include pharma, pharmaceutical, industry, business, health, care, costs, drugs, therapy, patents, pipeline, generics, manufacturers, funding, innovation, Health, Humanities, Social, Science, Medicine, Business, economy, discussion, talking, and interview.

The social media platforms allow viewers to rate and comment a published informational item. The action portion 604 provides the viewer necessary tools for responding to the informational item. The action portion 604 includes an icon representing a favorable view of the informational item (e.g., “Like”), an icon representing a negative view of the informational item (e.g., a hand with the thumb pointing downward), an icon representing an action to post comments (e.g., “Add to”), and an icon representing a sharing function (e.g., “Share”). A viewer may use any of the above described icons to rate the movie or post comments.

Social media platforms such as YouTube may also provide results of a preliminary data mining process on viewer-related data of the informational item. The report portion 610 summarizes such results, which include a total number of viewers (e.g. “9758”), a representative chart, and ratings from some viewers (e.g. “19 likes, 2 dislikes”).

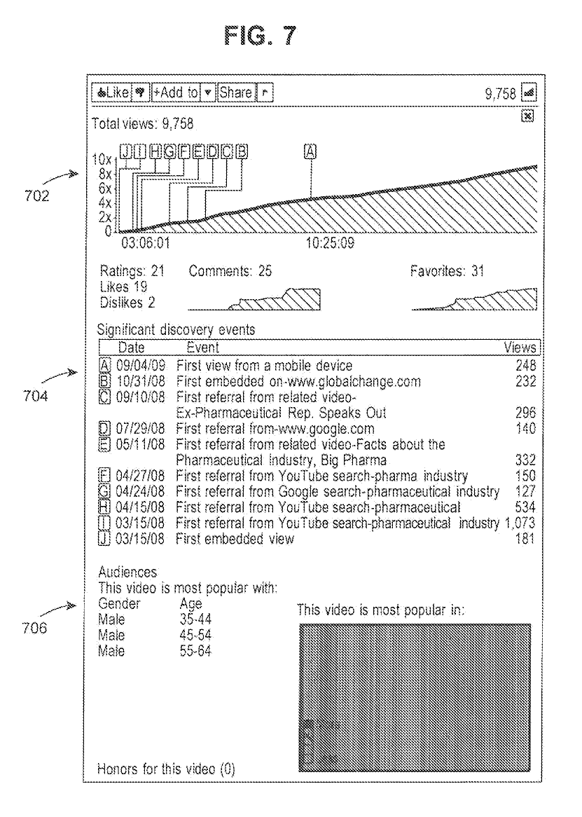

FIG. 7 illustrates exemplary data mining results on viewer-related data.

The data mining results may include a graphical portion 702 that displays a plurality of charts showing data mining results, a describing portion 704 that describes discovery events of the data, and a statistical portion 706 that summarizes statistics of the viewer-related data. The graphical portion 702 can show a plurality of charts. An exemplary chart shows the accumulation of total viewers of the informational, item with regard to time. Another exemplary chart shows the accumulation of comments with regard to time. Another exemplary chart shows the accumulation of favorites with regard to time. The graphical portion 702 may also show events on the charts and may also include ratings of the informational item. The describing portion 704 describes in detail events with regard to the informational item, such as time of first view from mobile device, time of first referral, etc. The statistical portion 706 includes statistics of the viewers such as number of views in each age group, geographical distributions of the viewers, etc.

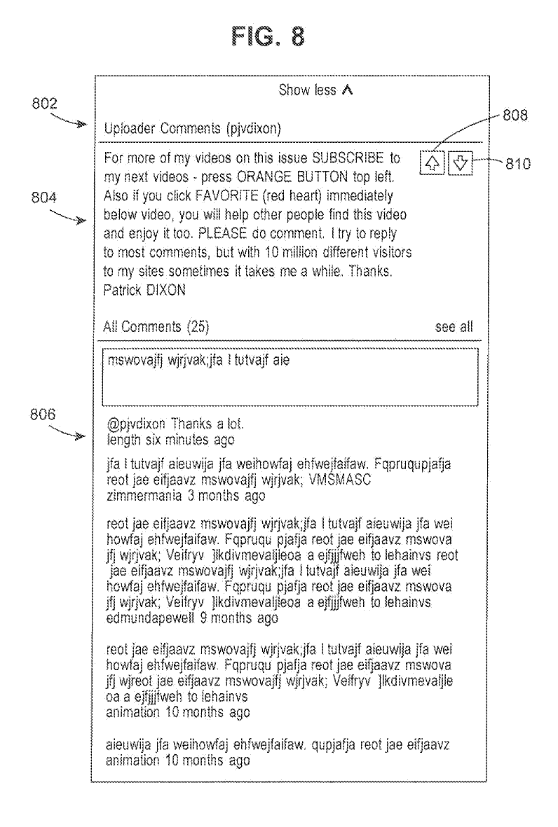

FIG. 8 illustrates exemplary comments about the informational item posted by a user. In general, social media platforms not only allow users to post comments on a published informational item, but also allow other users to rate and discuss a particular comment. For example, after a first user gives a first comment, other users can rate the first comment according to a 1 to 10 scale with 10 being most useful and 1 being least useful.

The portion 802 in FIG. 8 includes a user identifier of a comment. For example, “pjvdixon” represents a user name of a user. The portion 804 includes the comments that posted by the user “pjvdixon.” The portion 804 also includes the time (e.g., “3 years ago”) when the comment is posted. The portion 808 and 810 allows a user to rate this comment. For example, an upward pointing arrow represents a positive rating to the comment, while a downward pointing arrow represents a negative rating to the comment. The portion 806 represents another user's (e.g., “wangflh”) comment on the comment of “pjvdixon”. The portion 806 also includes the time when this comment was posted.

It is noted that other social media platforms or file sharing websites may have similar components in their data format with the examples illustrated in FIGS. 6 to 8. It is also noted that reduction or addition of data components to the examples illustrated in FIGS. 6 to 8 may be used by social media platforms. It is noted that the system and method according to the system not only collects the exemplary data illustrated in FIGS. 6 to 8 but also collects other related information such as co-mordid conditions, duration of medical condition, social variables, e.g., smoking, alcohol or drug use, etc.

As noted above, although the present disclosure describes exemplary embodiments in the context of a Phase IV Clinical Trial, embodiments need not be limited to Phase IV Clinical Trials. According to other embodiments, patients in Phase 0 to Phase III clinical trials can be induced or allowed to post comments about a drug or a treatment on a social media platform. The present disclosure may be equally applied to Phase 0 to Phase III clinical trials to, inter alia, track trial related data from online sources, a user's profile data, user's connection, metadata of a comment, etc. Others include any online data tracking and mining activity involved in pharmacovigilance.

Furthermore, embodiments in accord with the present disclosure can be applied in individual jurisdictions or in multiple jurisdictions. For example, embodiments can be implemented both in the U.S. and abroad. Whether implemented in a single jurisdiction or in multiple jurisdictions, embodiments as disclosed herein can be configured to track data in a single language or multiple languages, both by translating to a single language or a set of languages and/or maintaining the documents in their source language or languages. According to an embodiment, data can first be translated, either manually or via machine translation (e.g. via commercial statistical machine translation software such as Google® Translate) or combinations thereof as known in the art. Then a data mining process can be implemented on the translated data. According to another embodiment, a data mining process can be implemented without any translation of the data.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Except to the extent necessary or inherent in the processes themselves, no particular order to steps or stages of methods or processes described in this disclosure, including the Figures, is implied. In many cases the order of process steps may be varied, and various illustrative steps may be combined, altered, or omitted, without changing the purpose, effect or import of the methods described.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device.

The application program can be uploaded to, and executed by, a machine comprising any suitable architecture.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A method, executed by a processor, for tracking patient's response during a clinical trial of a medical treatment, comprising:
publishing an informational item about the clinical trial to at least one social media platform;
inducing patients to post trial related response at the at least one social media platform;
aggregating patients' responses from the at least one social media platform; and
analyzing aggregated patients' responses to obtain knowledge related to the clinical trial.

2. The method according to claim 1, further comprising:
aggregating search queries from at least one search engine; and
analyzing the search queries to obtain knowledge related to the clinical trial.

3. The method according to claim 1, further comprising:
publishing the informational item to at least one file sharing website;
aggregating download information for informational item; and
analyzing the download information to obtain knowledge related to the clinical trial.

4. The method according to claim 1, further comprising:
encrypting identity information of a patient.

5. The method according to claim 1, wherein metadata associated with a patient's response is also aggregated and analyzed.

6. The method according to claim 1, wherein the social media platform includes Facebook, Google+, Twitter, YouTube, LiveJournal, MySpace or LinkedIn.

7. The method according to claim 2, wherein the search engine includes Google, Bing, or Yahoo.

8. The method according to claim 3, wherein the file sharing website includes BitTorrent, EMule, or DocShare.

9. A system for tracking patient's response during a clinical trial of a medical treatment, comprising:
publishing means for publishing an informational item about the clinical trial to at least one social media platform;
inducing means for inducing patients to post trial related response at the at least one social media platform;
aggregating means for aggregating patients' responses from the at least one social media platform; and
analyzing means for analyzing aggregated patients' responses to obtain knowledge related to the clinical trial.

10. The system according to claim 9, wherein the aggregating means further aggregates search queries from at least one search engine; and
the analyzing means further analyzes the search queries to obtain knowledge related to the clinical trial.

11. The system according to claim 9, wherein the publishing means further publishes the informational item to at least one file sharing website, the aggregating means aggregates download information for informational item from the at least one file sharing website, and the analyzing means analyzes the download information to obtain knowledge related to the clinical trial.

12. The system according to claim 9, further comprising:
encrypting means for encrypting identity information of a patient.

13. The system according to claim 9, wherein metadata associated with a patient's response is also aggregated.

14. The system according to claim 9, wherein the social media platform includes Facebook, Google+, Twitter, YouTube, LiveJournal, MySpace or LinkedIn.

15. The system according to claim 10, wherein the search engine includes Google, Bing, or Yahoo.

16. The system according to claim 11, wherein the file sharing website includes BitTorrent, EMule, or DocShare.

17. A non-transitory storage medium storing an executable program that, when executed, causes a processor to track patient's response during a clinical trial of a treatment, the executable program comprising:
publishing an informational item about the clinical trial to at least one social media platform;
inducing patients to post trial related response at the at least one social media platform;
aggregating patients' responses from the at least one social media platform; and
analyzing aggregated patients' responses to obtain knowledge related to the clinical trial.

18. A method, executed by a processor, for tracking patient's response during a clinical trial of a medical treatment, comprising:
aggregating search queries from at least one search engine; and
analyzing the search queries to obtain knowledge related to the clinical trial.

19. The method according to claim 18, further comprising aggregating metadata of search queries,
wherein the metadata of search queries include an IP address.

20. A system for tracking patient's response during a clinical trial of a medical treatment, comprising:
aggregating means for aggregating search queries from at least one search engine; and
analyzing means for analyzing the search queries to obtain knowledge related to the clinical trial.

21. The system according to claim 20, wherein the aggregating means further aggregates metadata of search queries, and
wherein the metadata includes an IP address.

22. A non-transitory storage medium storing an executable program that, when executed, causes a processor to track patient's response during a clinical trial of a treatment, the executable program comprising:
aggregating search queries from at least one search engine; and
analyzing the search queries to obtain knowledge related to the clinical trial.

23. A method, executed by a processor, for tracking patient's response during a clinical trial of a medical treatment, comprising:
publishing the informational item to at least one file sharing website;
aggregating download information for informational item; and
analyzing the download information to obtain knowledge related to the clinical trial.

24. The method according to claim 13, further comprising aggregating metadata of search queries,
wherein the metadata of search queries include an IP address.

25. A system for tracking patient's response during a clinical trial of a medical treatment, comprising:
publishing means for publishing the informational item to at least one file sharing website;
aggregating means for aggregating download information for informational item; and
analyzing means for analyzing the download information to obtain knowledge related to the clinical trial.

26. The system according to claim 25, wherein the aggregating means further aggregates metadata of search queries, and
wherein the metadata includes IP address.

27. A non-transitory storage medium storing an executable program that, when executed, causes a processor to track patient's response during a clinical trial of a treatment, the executable program comprising:
publishing means for publishing the informational item to at least one file sharing website;
aggregating means for aggregating download information for informational item; and
analyzing means for analyzing the download information to obtain knowledge related to the clinical trial.
